(19) United States
(12) Patent Application Publication
(10) Pub. No.: US 2026/0128395 A1
(43) Pub. Date: May 7, 2026

(54) BATTERY MODULE AND BATTERY SYSTEM

(71) Applicant: SAMSUNG SDI CO., LTD., Yongin-Si (KR)

(72) Inventor: Sangjin HONG, Yongin-Si (KR)

(21) Appl. No.: 19/366,196

(22) Filed: Oct. 22, 2025

(30) Foreign Application Priority Data
Nov. 6, 2024 (KR) 10-2024-0156453

(51) Int. Cl. H01M 10/42; H01M 10/48; H01M 50/209; H01Q 1/22

(52) U.S. Cl. CPC H01M 10/425; H01M 10/482; H01M 10/486; H01M 50/209; H01Q 1/22; H01M 2010/4271; H01M 2010/4278

(57) ABSTRACT

A battery module includes: a plurality of cells; a plurality of sensors to measure at least one of a voltage or a temperature of at least some of the plurality of cells; a control circuit connected with the plurality of sensors via a plurality of cables; a wireless communication circuit connected with the control circuit, and to communicate with an external device; and an antenna connected with the wireless communication circuit. The plurality of cables and the antenna are adjacent to each other.

### CROSS-REFERENCE TO RELATED APPLICATION

The present application claims priority to and the benefit of Korean Patent Application No. 10-2024-0156453, filed on Nov. 6, 2024, in the Korean Intellectual Property Office, the entire disclosure of which is incorporated by reference herein.

### BACKGROUND

### 1. Field

Aspects of embodiments of the present disclosure relate to a battery module and a battery system.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A battery module may include a plurality of secondary batteries (or cells) connected in series and/or in parallel with one another. For efficient management of the battery module, a battery management system (BMS) may transmit and receive information by using the battery module and a wire communication.

The above information disclosed in this Background section is for enhancement of understanding of the background of the present disclosure, and therefore, it may contain information that does not constitute related (or prior) art.

### SUMMARY

In a case of using the wire communication, a cable for the wire communication may make the system more complicated, and may cause a spatial restriction.

Embodiments of the present disclosure may be directed to a battery module and a battery system.

These and other aspects and features of the present disclosure will be described in or will be apparent from the following description of embodiments of the present disclosure.

According to one or more embodiments of the present disclosure, a battery module includes: a plurality of cells; a plurality of sensors configured to measure at least one of a voltage or a temperature of at least some of the plurality of cells; a control circuit connected with the plurality of sensors via a plurality of cables; a wireless communication circuit connected with the control circuit, and configured to communicate with an external device; and an antenna connected with the wireless communication circuit. The plurality of cables and the antenna are adjacent to each other.

In an embodiment, the plurality of cables and the antenna may be connected to the control circuit and the wireless communication circuit, respectively, by a single connector.

In an embodiment, as the plurality of cables becomes farther from the single connector, a number of the plurality of cables may be decreased.

In an embodiment, as the plurality of cables becomes farther from the single connector, areas of the plurality of cables may be decreased.

In an embodiment, an area of the antenna may be increased by the areas of the plurality of cables that may be decreased as the plurality of cables become farther from the single connector.

In an embodiment, the antenna may include a first sub-antenna having one end connected with the single connector, and a second sub-antenna connected to another end of the first sub-antenna.

In an embodiment, an area of the second sub-antenna may be wider than an area of the first sub-antenna.

In an embodiment, each of the first sub-antenna and the second sub-antenna may have a plate shape.

In an embodiment, the antenna may include a first branch that may extend from the single connector, a second branch that may be branched at a first branch point of the first branch, and a third branch that may be branched at a second branch point of the first branch.

In an embodiment, a distance between the second branch point and the single connector may be longer than a distance between the first branch point and the single connector, and a number of branches of the third branch may be larger than a number of branches of the second branch.

In an embodiment, the plurality of cables and the antenna may be electrically insulated from each other.

In an embodiment, an area of the antenna may be increased as the antenna becomes farther from the single connector.

In an embodiment, the plurality of cells may be aligned along one direction, and the antenna and the plurality of cables may extend in a direction parallel to that of the aligned plurality of cells.

In an embodiment, the battery module may further include a top plate covering the plurality of cells, and the plurality of cables and the antenna may be located between the top plate and the plurality of cells.

According to one or more embodiments of the present disclosure, a battery system includes: a battery module including a plurality of cells; and a battery management system (BMS) configured to manage the battery module. The battery module further includes: a plurality of sensors configured to measure at least one of a voltage or a temperature of at least some of the plurality of cells; a control circuit connected with the plurality of sensors via a plurality of cables; a wireless communication circuit connected with the control circuit, and configured to communicate with an external device; and an antenna connected with the wireless communication circuit. The plurality of cables and the antenna may be adjacent to each other, and the battery module may be configured to communicate with the battery management system by utilizing the wireless communication circuit.

In an embodiment, the plurality of cables and the antenna may be connected with the control circuit and the wireless communication circuit, respectively, by a single connector.

In an embodiment, as the plurality of cables becomes farther from the single connector, a number of the plurality of cables may be decreased.

In an embodiment, as the plurality of cables becomes farther from the single connector, an area of the plurality of cables may be decreased.

In an embodiment, an area of the antenna may be increased by the area of the plurality of cables that may be decreased as the plurality of cables becomes farther from the single connector.

In an embodiment, the plurality of cells may be aligned along one direction, and the antenna and the plurality of cables may extend in a direction parallel to that of the aligned plurality of cells.

According to some embodiments of the present disclosure, a cable used for a wire communication may be omitted by transmitting and receiving data associated with a battery. Therefore, a battery system may be simplified, and a spatial restriction may be resolved (e.g., may be prevented or reduced).

According to some embodiments of the present disclosure, non-used spaces (e.g., spaces that are typically not used) may be efficiently utilized by disposing an antenna adjacent to a cable. In some embodiments, the farther the antenna becomes from a connector, the wider an area of the antenna may become, and thus, a communication performance may be improved.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a view illustrating an example of a battery cell according to an embodiment of the present disclosure.

FIG. 2 is a cross-sectional view illustrating an example of a battery cell according to an embodiment of the present disclosure.

FIG. 3 is a view illustrating an example of disassembling a part of a battery module according to an embodiment of the present disclosure.

FIG. 4 is a view illustrating an example of a circuit substrate according to an embodiment of the present disclosure.

FIG. 5 is a view illustrating an example of a circuit substrate according to an embodiment of the present disclosure.

FIG. 6 is a view illustrating an example of a battery management module according to an embodiment of the present disclosure.

FIG. 7 is a plan view illustrating an example of a part of a battery module according to an embodiment of the present disclosure.

FIG. 8 is a view illustrating an example of a communication method of a battery system according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

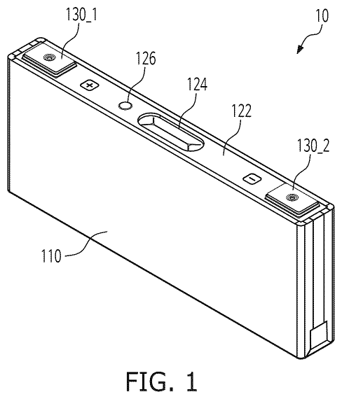

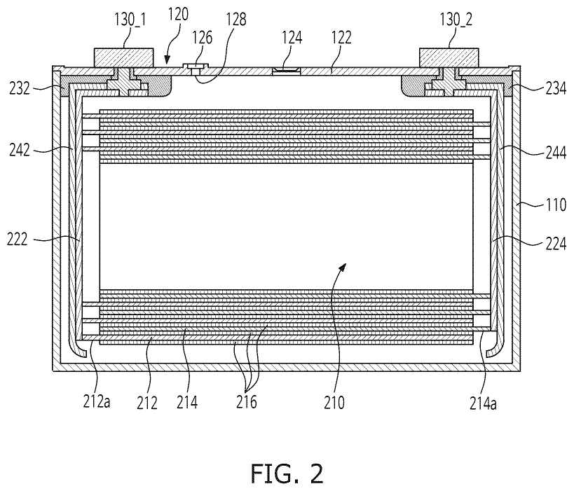

FIG. 1 is a view illustrating an example of a battery cell (10) according to an embodiment of the present disclosure. FIG. 2 is a cross-sectional view illustrating an example of the battery cell (10) according to an embodiment of the present disclosure.

Referring to FIGS. 1 and 2, the secondary battery 10 according to one or more embodiments of the present disclosure may include at least one electrode assembly 210 wound with a separator 216 as an insulator between the positive electrode 212 and the negative electrode 214, a case 110 in which the electrode assembly 210 is received (or accommodated) therein, and a cap assembly 120 coupled to an opening of the case 110.

The secondary battery 10 according to one or more embodiments will now be described as an example of a prismatic lithium ion secondary battery. However, the present disclosure is not limited thereto, and suitable aspects, features and principles described herein may be applied to various other types of batteries, such as lithium polymer batteries and/or cylindrical batteries.

Each of the positive electrode 212 and the negative electrode 214 may include a current collector made of a thin metal foil having a coated portion on which an active material is coated and an uncoated portion 212a, 214a on which an active material is not coated.

The positive electrode 212 and the negative electrode 214 are wound after interposing the separator 216, which is an insulator, therebetween. However, the present disclosure is not limited thereto, and the electrode assembly 210 may have a structure in which a positive electrode 212 and a negative electrode 214, each made of a plurality of sheets, are alternately stacked with a separator interposed therebetween.

The case 110 may form the overall outer appearance of the secondary battery 10 and may be made of a conductive metal, such as aluminum, aluminum alloy, or nickel-plated steel. In addition, the case 110 may provide a space in which the electrode assembly 210 is accommodated.

The cap assembly 120 may include a cap plate 122 covering an opening in the case 110, and the case 110 and the cap plate 122 may be made of a conductive material. The positive and negative electrode terminals 130_1 and 130_2 electrically connected to the positive electrode 212 and the negative electrode 214, respectively, may be installed to penetrate (or extend through) the cap plate 122 and protrude outwardly therethrough.

In addition, outer peripheral surfaces (e.g., circumferential surfaces) of upper pillars of the positive and negative electrode terminals 130_1 and 130_2 protruding outwardly from the cap plate 122 may be threaded and may be fixed to the cap plate 122 by utilizing nuts.

However, the present disclosure is not limited thereto, and the positive and negative electrode terminals 130_1 and 130_2 may have a rivet structure and may be riveted or welded to the cap plate 122.

In addition, the cap plate 122 may be made of a thin plate and may be coupled to the opening in the case 110, and an electrolyte injection port 128 into which a sealing stopper 126 may be installed may be located (e.g., formed) in the cap plate 122, and a vent portion 124 having a notch may be installed.

The positive and negative electrode terminals 130_1 and 130_2 may be electrically connected to current collectors including first and second current collectors 222 and 224 (hereinafter referred to as positive and negative current collectors) by being bonded or coupled (e.g., by welding) to the positive uncoated portion 212a and the negative electrode uncoated portion 214a, respectively.

For example, the positive and negative electrode terminals 130_1 and 130_2 may be coupled by welding to the positive and negative electrode current collectors 222 and 224, respectively. However, the present disclosure is not limited thereto, and the positive and negative electrode terminals 130_1 and 130_2 and the positive and negative electrode current collectors 222 and 224 may be integrally formed in one or more embodiments.

In addition, an insulation member may be installed between the electrode assembly 210 and the cap plate 122. The insulation member may include first and second lower insulation members 60 and 70, and each of the first and second lower insulation members 60 and 70 may also have a portion located between the electrode assembly 210 and the case 110.

In addition, according to one or more embodiments of the present disclosure, one end of a separation member may face one side of the electrode assembly 210 and may be installed between the insulation member and the positive or negative electrode terminals 130_1 and 130_2.

In one or more embodiments, the separation member may include first and second separation members 242 and 244.

Accordingly, the positive and negative electrode terminals 130_1 and 130_2, which may be coupled by welding to the positive and negative electrode current collectors 222 and 224, may be coupled to first ends of the first and second lower insulation members 232 and 234 and the first and second separation members 242 and 244.

The battery cell (10) may be a lithium battery cell, a sodium battery cell, and/or the like. However, the present disclosure is not limited thereto, and the battery cell (10) may include all kinds of suitable cells that may repetitively provide electricity by charging and discharging. In an embodiment, in a case where the battery cell (10) is a lithium battery cell, the lithium battery cell may have improved (e.g., may be excellent in) shelf-life properties and high-rate properties, and thus, may be used for an electric vehicle (EV). For example, the lithium battery cell may be used for a hybrid electric vehicle, such as plug-in hybrid electric vehicle (PHEV). In some embodiments, the lithium battery cell may be used in a field where a large amount of electric power storage is required or desired. For example, the lithium battery cell may be used for an electric bicycle, an electric tool, an energy storage system (ESS), and/or the like.

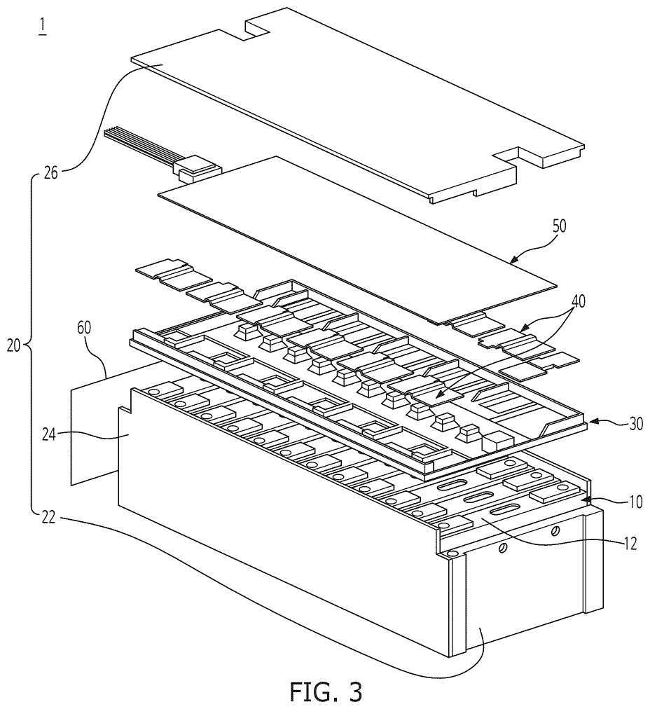

FIG. 3 is a view illustrating an example of disassembling a part of a battery module (1) according to an embodiment of the present disclosure.

Referring to FIG. 3, the battery module (1) according to an embodiment of the present disclosure may include a plurality of battery cells (10), a frame that accommodates the plurality of battery cells (10), a plurality of bus bars (40) electrically connected to the plurality of battery cells (10), a bus bar holder (30) that supports the plurality of bus bars (40), and a circuit substrate (50) electrically connected to the plurality of bus bars (40) and mounted with various circuits and parts. The battery module (1) may be referred to as a battery pack. According to some embodiments, the battery module (1) may be included in a vehicle or an energy storage system.

The battery module (1) may include the plurality of battery cells (10). In an embodiment, the plurality of battery cells (10) in the battery module (1) may be arranged along one direction, such that wider surfaces thereof face one another.

In an embodiment, each of the battery cells (10) may include a case, an electrode assembly that is accommodated inside the case with an electrolyte, and a cap plate (12) to seal the case. The electrode assembly may be formed o include a negative electrode plate, a separator, and a positive electrode plate that are wound or stacked in that order. A negative electrode active material, such as graphite and/or carbon, may be applied or coated on a negative electrode plate formed of a metal foil, such as copper, a copper alloy, nickel, and/or a nickel alloy. An active material, such as transition metal oxide, may be applied or coated on a positive electrode plate formed of a metal foil, such as aluminum or an aluminum alloy. An uncoated portion on which an active material is not applied may be formed on each of the negative electrode plate and the positive electrode plate. A negative electrode uncoated portion may be connected with a negative electrode tab, and a positive electrode uncoated portion may be connected with a positive electrode tab. The negative electrode tab and the positive electrode tab connected in such a way may be electrically connected to a negative electrode terminal and a positive electrode terminal formed on the cap plate (12). The negative electrode terminal and the positive electrode terminal formed on the cap plate (12) may be electrically connected to the bus bars (40). However, the structure of the battery cell (10) is not limited thereto, and may be variously modified as needed or desired. In some embodiments, the number and the arrangement of the battery cells (10) are also not limited to those illustrated in FIG. 3, and may be variously modified as needed or desired.

The plurality of battery cells (10) may be accommodated in a frame (20). In an embodiment, the frame (20) may include a pair of end plates (22) that come into contact with a battery cell (10) on an outermost side in accordance with an arrangement direction of the battery cells (10), a pair of side plates (24) that are orthogonally coupled to the end plates (22), and a top plate (26) that is disposed on an upper portion of the circuit substrate (50). In some embodiments, a lower portion of the frame (20) may be provided with a bottom plate, and thus, the lower portion of the frame (20) may support the battery cells (10). The battery cells (10), the bus bar holder (30), the bus bars (40), and the circuit substrate (50) may be accommodated inside the frame (20).

The bus bar holder (30) may be disposed on an upper portion of the cap plate (12) as in FIG. 3, and may support the bus bars (40). For example, the bus bar holder (30) may be a rectangular plate material or substantially a rectangular plate material, and may be manufactured or formed with an insulating material.

The bus bar holder (30) may include a plurality of through holes formed thereon or therethrough, through which the positive electrode terminal and the negative electrode terminal of the cap plate (12) may be exposed. The positive electrode terminal and the negative electrode terminal may be exposed through the through holes formed in the bus bar holder (30), and the bus bars (40) may be electrically connected to the exposed positive electrode terminal and the exposed negative electrode terminal.

The bus bars (40) may electrically connect the positive electrode terminal and the negative electrode terminal. The bus bars (40) may connect the plurality of battery cells in series and/or in parallel with each other. As such, the plurality of the bus bars (40) may be provided. In an embodiment, one of the bus bars (40) may electrically connect the positive electrode terminal of one battery cell (10) and a positive electrode terminal or a negative electrode terminal of another battery cell (10) to each other. Additionally or as another example, one of the bus bars (40) may electrically connect the negative electrode terminal of one battery cell (10) and a positive electrode terminal or a negative electrode terminal of another battery cell (10) to each other. The bus bars (40) may be connected with the positive electrode terminal and/or the negative electrode terminal by welding and/or the like. An area other than the positive electrode terminal and the negative electrode terminal in the battery cells (10) may be insulated from the bus bars (40) by the bus bar holder (30). The circuit substrate (50) may be interposed between the bus bars (40) and the top plate (26), and the bus bars (40) may be electrically connected with the circuit substrate (50).

A plurality of sensors that measures a voltage and/or a temperature of at least some of the battery cells (10), and various parts or circuits for a control and/or a management of the battery cell (10), may be mounted on the circuit substrate (50). In an embodiment, the circuit substrate (50) may be electrically connected with an exterior of the battery module (1) via a connector.

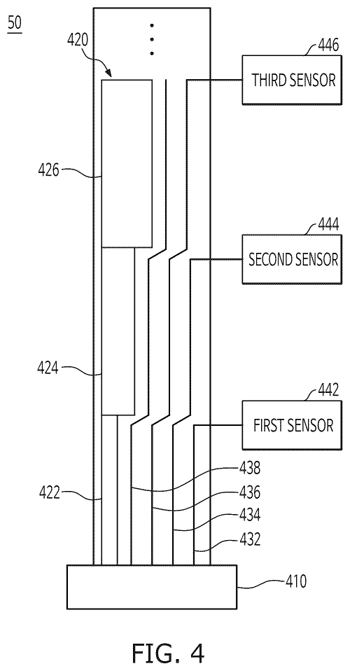

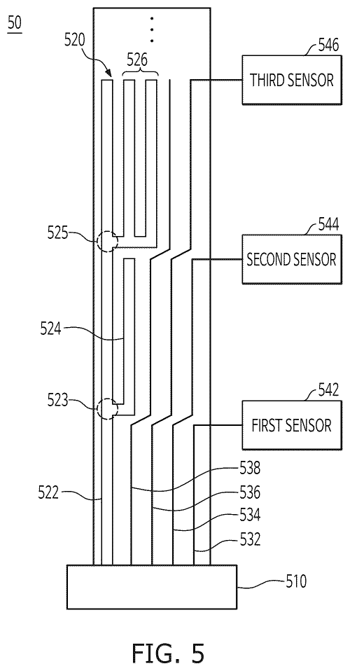

In an embodiment, the circuit substrate (50) may include a plurality of cables connected with a plurality of sensors, and an antenna disposed adjacent to the plurality of cables. The circuit substrate (50) including the plurality of cables and the antenna will be described in more detail below with reference to FIGS. 4 and 5.

In an embodiment, the circuit substrate (50) may be in a rectangular or substantially rectangular shape, and may be disposed such that a long side direction thereof coincides with an arrangement direction of the battery cells (10). The circuit substrate (50) may have a suitable size to cover a suitable size (e.g., a certain or predetermined size) or more of an area of the bus bar holder (30), because the circuit substrate (50) may be connected with the bus bars (40). The circuit substrate (50) may have a suitable size in order to be adjacent to at least an installation area of the bus bars (40) for smoother connection with the bus bars (40). For example, the circuit substrate (50) may have a short side length corresponding to an interval between left side bus bars (40) and right side bus bars (40) illustrated in FIG. 3. In some embodiments, the circuit substrate (50) may have a long side length that is as long as a sum of the widths of the left side bus bars (40) or the right side bus bars (40) in accordance with the arrangement direction of the battery cells (10).

In an embodiment, the antenna and the plurality of cables of the circuit substrate (50) may be disposed to extend in a direction parallel to or substantially parallel to the aligned plurality of battery cells (10). In some embodiments, the plurality of cables and the antenna may be disposed between the plurality of battery cells (10) and the top plate (26).

FIG. 3 illustrates one circuit substrate (50), but the present disclosure is not limited thereto, and the circuit substrate (50) may be divided into a plurality of circuit substrates as needed or desired.

In an embodiment, the battery module (1) may further include a battery management module (e.g., a battery management controller or a battery management circuit) (60). The battery management module (60) may be disposed on an end plate of a back surface portion from among the pair of end plates (22), as illustrated in FIG. 3. In some embodiments, the battery management module (60) may be connected with the circuit substrate (50).

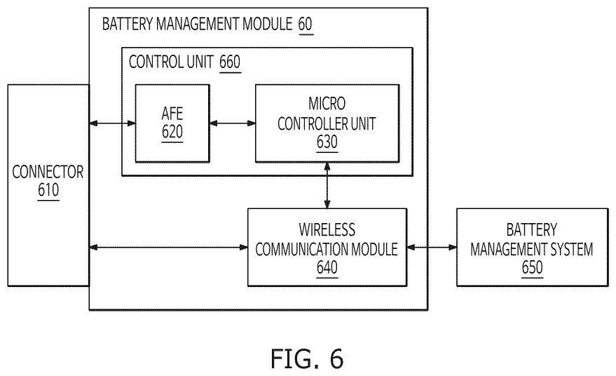

In an embodiment, the battery management module (60) may include a control unit (e.g., a controller or a control circuit) connected with the plurality of sensors via the plurality of cables, and a wireless communication module (e.g., a wireless communication device or circuit) that is connected with the control unit and communicates with an external device. The plurality of cables and the antenna of the circuit substrate (50) may be connected with the control unit and the wireless communication module by using a single connector. In some embodiments, the battery management module (60) may transmit and receive data associated with the battery to and from an external battery management system (BMS) by using the wireless communication module. An example of a configuration of the battery management module (60) will be described in more detail below with reference to FIG. 6.

By transmitting and receiving data associated with the battery via a wireless communication, a cable used in a wire communication may be omitted. Therefore, the battery system may be simplified, and a spatial restriction may be resolved (e.g., may be prevented or reduced).

FIG. 4 is a view illustrating an example of the circuit substrate (50) according to an embodiment of the present disclosure.

In an embodiment, the circuit substrate (50) may include an antenna (420) and a plurality of cables (432, 434, 436, 438) connected with a single connector (410). The antenna (420) may be connected with a wireless communication module (e.g., a wireless communication device or circuit) of a battery management module (e.g., a battery management controller or circuit, for example such as 60 of FIG. 3) by using the single connector (410). In some embodiments, the plurality of cables (432, 434, 436, 438) may be connected with a control unit (e.g., a controller or a control circuit) of the battery management module by using the single connector (410). In some embodiments, the antenna (420) and the plurality of cables (432, 434, 436, 438) may be electrically insulated from each other.

In an embodiment, the plurality of cables may be connected with the plurality of sensors. For example, a first cable (432) may be connected with a first sensor (442), a second cable (434) may be connected with a second sensor (444), and a third cable (436) may be connected with a third sensor (446). Each of the plurality of sensors may be connected with a positive electrode terminal, a negative electrode terminal, or the like of each of the plurality of battery cells by a welding connection and/or the like.

In an embodiment, a number of the plurality of cables (432, 434, 436, 438) may be decreased as the cables become farther (e.g., become more distant) from the connector (410). Referring to FIG. 4, the plurality of battery cells may be aligned along one direction, and the plurality of sensors connected to each of the plurality of battery cells may be aligned along a direction parallel to or substantially parallel to the plurality of battery cells. In some cases, as a sensor becomes closer to the connector (410), a length of the cable connected to the sensor may become shorter. In other words, the first cable (432) to the fourth cable (438) may be disposed in an area between an region corresponding to the first sensor (442) and the connector (410) of the circuit substrate (50), and the second cable (434) to the fourth cable (438) may be disposed in an area between a region corresponding to the first sensor (442) and a region corresponding to the second sensor (444) of the circuit substrate (50). Similarly, the third cable 436 and the fourth cable 438 may be disposed in an area between a region corresponding to the second sensor (444) and a region corresponding to the third sensor (446) of the circuit substrate (50), and so on and so forth. Therefore, as the plurality of cables become farther (e.g., more distant) from the connector (410), areas of the plurality of cables may be decreased.

In an embodiment, the antenna (420) may include a first sub-antenna (422) of which one end thereof is connected with the connector (410), a second sub-antenna (424) of which one end thereof is connected to another end (e.g., an opposite end) of the first sub-antenna (422), and a third sub-antenna (426) connected to another end (e.g., an opposite end) of the second sub-antenna (424). The antenna (420) may be in a plate shape. In other words, the antenna (420) may be in an integrated plate shape in which the first sub-antenna (422), the second sub-antenna (424), and the third sub-antenna (426) are linked to one another without branches. In some embodiments, a position of a sub-antenna may be determined based on a position of a sensor. For example, the other end of the first sub-antenna (422) to which the one end of the second sub-antenna (424) is connected may correspond to a position of the first sensor (442). In other words, the second sub-antenna (424) may be disposed in an area between the region corresponding to the first sensor (442) and the region corresponding to the second sensor (444) of the circuit substrate (50). Similarly, the other end of the second sub-antenna (424) to which the one end of the third sub-antenna (426) is connected may correspond to a position of the second sensor (444). In other words, the third sub-antenna (426) may be disposed in an area between the region of the second sensor (444) and the region of the third sensor (446) of the circuit substrate (50).

In an embodiment, as the antenna (420) becomes farther (e.g., becomes more distant) from the connector (410), an area of the antenna (420) may be increased. In more detail, an area of the second sub-antenna (424) may be wider than an area of the first sub-antenna (422). In some embodiments, an area of the third sub-antenna (426) may be wider than an area of the second sub-antenna (424). In other words, the area of the antenna (420) may be increased by the area of the plurality of cables (432, 434, 436, 438), which is decreased as the plurality of cables becomes farther (e.g., becomes more distant) from the connector (410).

By disposing the antenna to be adjacent to the cables, it may be possible to more efficiently utilize a non-used space (e.g., a space that is typically not utilized). In some embodiments, the area of the antenna becomes wider as the antenna becomes farther from the connector, and thus, it may be possible to improve a communication performance.

FIG. 5 is a view illustrating an example of the circuit substrate (50) according to an embodiment of the present disclosure.

Referring to FIG. 5, in an embodiment, the circuit substrate (50) may include an antenna (520) connected with a single connector (510), and a plurality of cables (532, 534, 536, 538) also connected with the single connector (510). The antenna (520) may be connected with a wireless communication module (e.g., a wireless communication device or circuit) of a battery management module (e.g., a battery management controller or circuit, for example, such as 60 of FIG. 3) by using the single connector (510). In some embodiments, the plurality of cables (532, 534, 536, 538) may be connected with a control unit (e.g., a controller or a control circuit) of the battery management module by using the single connector (510). In other embodiments, the antenna (520) and the plurality of cables (532, 534, 536, 538) may be electrically insulated from each other.

In an embodiment, the plurality of cables may be connected with the plurality of sensors. For example, a first cable (532) may be connected with a first sensor (542), a second cable (534) may be connected with a second sensor (544), and a third cable may be connected with a third sensor (546). Each of the plurality of sensors may be connected with a positive electrode terminal, a negative electrode terminal, or the like of each of the plurality of battery cells by using a welding connection and/or the like.

In an embodiment, the number of the plurality of cables (532, 534, 536, 538) may be decreased as the cables become farther (e.g., become more distant) from the connector (510). Referring to FIG. 5, the plurality of battery cells may be aligned in one direction, and the plurality of sensors connected to each of the plurality of battery cells may be aligned in a direction parallel to or substantially parallel to the plurality of battery cells. In some embodiments, as a sensor becomes closer to the connector (510), a length of the cable connected to the sensor may become shorter. In other words, the first cable (532) to the fourth cable (538) may be disposed in an area between a region corresponding to the first sensor (542) and the connector (510) of the circuit substrate (50), and the second cable (534) to the fourth cable (538) may be disposed in an area between a region corresponding to the first sensor (542) and a region corresponding to the second sensor (544) of the circuit substrate (50). Therefore, as the plurality of cables become farther from the connector (510), areas of the plurality of cables may be decreased.

In an embodiment, the antenna (520) may include a first branch (522) that extends from the connector (510), a second branch (524) that is branched at a first branch point (523) of the first branch (522), and a third branch (526) that is branched at a second branch point (525) of the first branch (522). A position of a branch point of the first branch (522) may be determined corresponding to a position of a sensor. For example, a position of the first branch point (523) at which the second branch (524) is branched from the first branch (522) may correspond to a position of the first sensor (542). In other words, the second branch (524) may be disposed in an area between the region corresponding to the first sensor (542) and the region corresponding to the second sensor (544) of the circuit substrate (50). Similarly, a position of the second branch point (525) at which the third branch (526) is branched from the first branch (522) may correspond to a position of the second sensor (544). In other words, the third branch (526) may be disposed in an area between the region corresponding to the second sensor (544) and the region corresponding to the third sensor (546) of the circuit substrate (50).

In an embodiment, as the antenna (520) becomes farther from the connector (510), an area of the antenna (520) may be increased. In more detail, a distance between the second branch point (525) and the connector (510) may be longer than a distance between the first branch point (523) and the connector (510). In some embodiments, a number of the third branches (526) that are branched at the second branch point (525) may be larger than a number of the second branches (524) that are branched at the first branch point (523). Therefore, the number of branches that are branched at the first branch (522) becomes increased as the branches become farther from the connector (510), and the area of the antenna (520) may be increased.

FIG. 6 is a view illustrating an example of the battery management module (60) according to an embodiment of the present disclosure.

In an embodiment, the battery management module (60) may be configured such that a state of the plurality of cells collected from a connector (610) is transmitted to a battery management system (650) and/or another battery management module. For example, the battery management module (60) may include a control unit (e.g., a controller or a control circuit) (660) and a wireless communication module (e.g., a wireless communication device or circuit) (640). The control unit (660) may include an analog front end (AFE) (620) and a micro controller unit (e.g., a microcontroller or a microcontroller circuit) (630).

In an embodiment, the battery management module (60) may be connected to a plurality of cells, and may monitor the state of the plurality of cells. For example, the battery management module (60) may acquire data associated with the state of the plurality of cells via a plurality of cables connected with a plurality of sensors that measures at least one of a current, a voltage, or a temperature of at least some of the plurality of cells. The plurality of cables may be connected with the AFE (620) by using the connector (610).

In an embodiment, the AFE (620) may measure a state of a current, a voltage, a temperature, and/or the like of the plurality of cells, which is an analog signal, and may convert the analog signal into a digital signal. For example, the AFE (620) may measure a state of a current, a voltage, a temperature, and/or the like of the plurality of cells, which is an analog signal, from the plurality of sensors via a cable connected with the AFE (620), and may convert the analog signal into a digital signal.

In an embodiment, the micro controller unit (630) may monitor a state of the plurality of cells based on information on the state of a voltage, a current, a temperature, and/or the like of each of the plurality of cells received from the AFE (620). For example, the micro controller unit (630) may determine whether or not the battery cell is in an overvoltage state or an undervoltage state, based on at least one information of the state of the voltage, the current, the temperature, and/or the like of each of the plurality of cells. As other examples, the micro controller unit (630) may sense a difference in a voltage among the plurality of cells based on at least one information of the state of the voltage, the current, the temperature, and/or the like of each of the plurality of battery cells. In some embodiments, in a case where the micro controller unit (228) may sense a difference in a voltage among the battery cells, the micro controller unit (228) may adjust the difference in the voltage among the plurality of cells by using a balancing circuit to balance voltages among the plurality of cells.

In an embodiment, the battery management module (60) may transmit information on a state of the plurality of batteries (e.g., information on the state of the cells) and information on a state of the battery management module (60) (e.g., information on defects of the battery management module and the like) to the battery management system (650). For example, the micro controller unit (630) may transmit information on a state of the plurality of batteries and information on a state of the battery management module (60) to the battery management system (650) through the wireless communication module (640). The wireless communication module (640) may include a radio frequency (RF) circuit, but the present disclosure is not limited thereto.

In an embodiment, the wireless communication module (640) may transmit and receive data to and from the battery management system (650) by using an antenna (e.g., 420 of FIG. 4 or 520 of FIG. 5). The wireless communication module (640) may be connected with the antenna by using the connector (610).

FIG. 6 illustrates that the battery management module (60) is in close or direct contact with the connector (610), but the present disclosure is not limited thereto, and the battery management module (60) and the connector (610) may be connected to each other while being spaced apart or separated from each other.

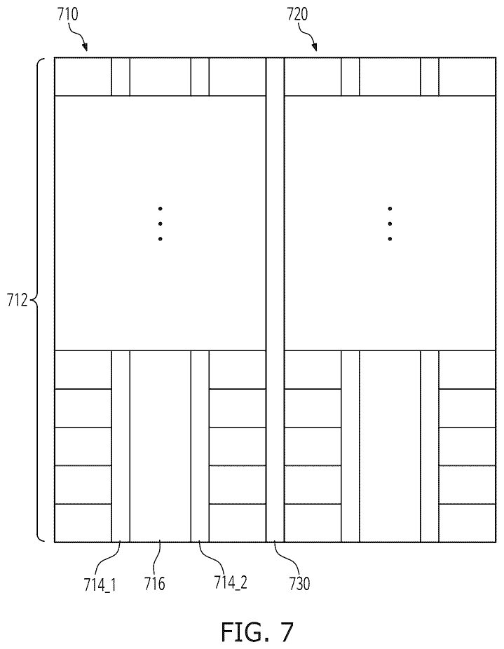

FIG. 7 is a plan view illustrating an example of a part of a battery module according to an embodiment of the present disclosure.

In an embodiment, the battery module may include a first battery module (710), a second battery module (720), and a connection member (730) that connects the first battery module (710) and the second battery module (720) to each other. The first battery module (710) may include a plurality of battery cells (712), a plurality of circuit substrates (714_1, 714_2), and a bus bar holder (716). The plurality of battery cells (712) of the first battery module (710) may be aligned along one direction. In some embodiments, the plurality of circuit substrates (714_1, 714_2) may be disposed in a direction parallel to or substantially parallel to the plurality of cells. In other words, an antenna and a plurality of cables included in the plurality of circuit substrates (714_1, 714_2) may be also disposed to extend in a direction parallel to or substantially parallel to that of the aligned plurality of cells. The second battery module (720) may be the same or substantially the same as (or similar to) the first battery module (710). In some embodiments, the first battery module (710) and the second battery module (720) may be extended to be long, and the longer the first battery module (710) and the second battery module (720) are extended, the more the area of the antenna included in the plurality of circuit substrates (714_1, 714_2) may be increased.

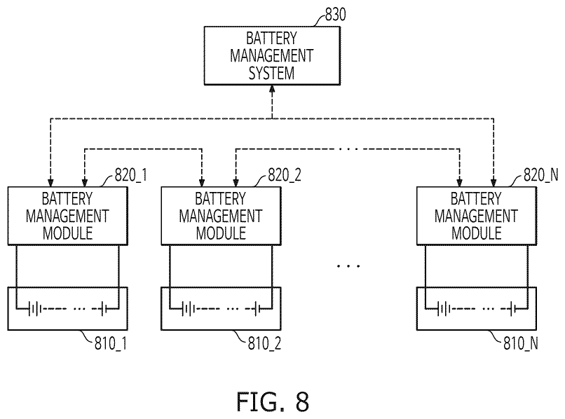

FIG. 8 is a view illustrating an example of a communication method of a battery system according to an embodiment of the present disclosure.

In an embodiment, the battery system may include a plurality of battery modules (810_1 to 810_n), where n is a positive integer, including a plurality of cells, and a battery management system (830) that manages the plurality of battery modules (810_1 to 810_n). Each of the battery management modules (820_1 to 820_n) may be connected to each of the battery modules (810_1 to 810_n), and may monitor a state of the battery cells inside the battery modules (810_1 to 810_n). In some embodiments, the battery management modules (820_1 to 820_n) may transmit and receive data to and from the battery management system (830). The battery management system (830) may receive information on a state of a battery cell associated with a battery management module from the battery management modules (820_1 to 820_n).

In an embodiment, each of the battery modules (810_1 to 810_n) may include a plurality of sensors that measures at least one of a voltage or a temperature of at least some of the plurality of cells, a control unit (e.g., a controller or a control circuit) that is connected to the plurality of sensors via a plurality of cables, a wireless communication module (e.g., a wireless communication device or circuit) that is connected with the control unit and communicates with an external device, and an antenna that is connected with the wireless communication module. The plurality of cables and the antenna may be disposed to be adjacent to each other. In some embodiments, the battery module may communicate with the battery management system (830) and/or other battery modules by using the wireless communication module.

In an embodiment, the battery system may be configured such that the battery management system (830) receives information on a state of a battery cell and/or information associated with defects of the battery management module from each of the battery management modules (820_1 to 820_n). For example, each of the battery management modules (820_1 to 820_n) may be perform a wireless communication with the battery management system (830), and each of the battery management modules (820_1 to 820_n) may transmit information on a state of the battery cell and/or information associated with defects of the battery management module to the battery management system (830). In some embodiments, each of the battery management modules (820_1 to 820_n) may transmit and receive a command received from the battery management system (830), information on the state of the battery cell, and information associated with defects of the battery management module.

FIG. 8 illustrates that the battery management module is spaced apart or separated from the battery modules, but the present disclosure is not limited thereto, and the battery module may include the battery management module.

The electronic or electric devices and/or any other relevant devices or components according to embodiments of the present disclosure described herein (e.g., the battery management module, the control unit, the micro controller unit, and/or the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME SYMBOLS

10: Battery cell

110: Case

122: Cap plate

124: Vent portion

126: Sealing stopper

130_1: Positive electrode terminal

130_2: Negative electrode terminal

What is claimed is:

1. A battery module comprising:
a plurality of cells;
a plurality of sensors configured to measure at least one of a voltage or a temperature of at least some of the plurality of cells;
a control circuit connected with the plurality of sensors via a plurality of cables;
a wireless communication circuit connected with the control circuit, and configured to communicate with an external device; and
an antenna connected with the wireless communication circuit,
wherein the plurality of cables and the antenna are adjacent to each other.

2. The battery module according to claim 1,
wherein the plurality of cables and the antenna are connected to the control circuit and the wireless communication circuit, respectively, by a single connector.

3. The battery module according to claim 2,
wherein, as the plurality of cables becomes farther from the single connector, a number of the plurality of cables is decreased.

4. The battery module according to claim 2,
wherein, as the plurality of cables becomes farther from the single connector, areas of the plurality of cables are decreased.

5. The battery module according to claim 4,
wherein an area of the antenna is increased by the areas of the plurality of cables that are decreased as the plurality of cables become farther from the single connector.

6. The battery module according to claim 2,
wherein the antenna comprises a first sub-antenna having one end connected with the single connector, and a second sub-antenna connected to another end of the first sub-antenna.

7. The battery module according to claim 6,
wherein an area of the second sub-antenna is wider than an area of the first sub-antenna.

8. The battery module according to claim 6,
wherein each of the first sub-antenna and the second sub-antenna has a plate shape.

9. The battery module according to claim 2,
wherein the antenna comprises a first branch that extends from the single connector, a second branch that is branched at a first branch point of the first branch, and a third branch that is branched at a second branch point of the first branch.

10. The battery module according to claim 9,
wherein a distance between the second branch point and the single connector is longer than a distance between the first branch point and the single connector, and
wherein a number of branches of the third branch is larger than a number of branches of the second branch.

11. The battery module according to claim 1,
wherein the plurality of cables and the antenna are electrically insulated from each other.

12. The battery module according to claim 2,
wherein an area of the antenna is increased as the antenna becomes farther from the single connector.

13. The battery module according to claim 1,
wherein the plurality of cells is aligned along one direction, and
wherein the antenna and the plurality of cables extend in a direction parallel to that of the aligned plurality of cells.

14. The battery module according to claim 11, further comprising a top plate covering the plurality of cells,
wherein the plurality of cables and the antenna are located between the top plate and the plurality of cells.

15. A battery system comprising:
a battery module comprising a plurality of cells; and
a battery management system (BMS) configured to manage the battery module,
wherein the battery module further comprises:
a plurality of sensors configured to measure at least one of a voltage or a temperature of at least some of the plurality of cells;
a control circuit connected with the plurality of sensors via a plurality of cables;
a wireless communication circuit connected with the control circuit, and configured to communicate with an external device; and
an antenna connected with the wireless communication circuit,
wherein the plurality of cables and the antenna are adjacent to each other, and
wherein the battery module is configured to communicate with the battery management system by utilizing the wireless communication circuit.

16. The battery system according to claim 15,
wherein the plurality of cables and the antenna are connected with the control circuit and the wireless communication circuit, respectively, by a single connector.

17. The battery system according to claim 16,
wherein, as the plurality of cables becomes farther from the single connector, a number of the plurality of cables is decreased.

18. The battery system according to claim 16,
wherein, as the plurality of cables becomes farther from the single connector, an area of the plurality of cables is decreased.

19. The battery system according to claim 18,
wherein an area of the antenna is increased by the area of the plurality of cables that are decreased as the plurality of cables becomes farther from the single connector.

20. The battery system according to claim 15,
wherein the plurality of cells is aligned along one direction, and
wherein the antenna and the plurality of cables extend in a direction parallel to that of the aligned plurality of cells.
